(19) United States
(12) Patent Application Publication
(10) Pub. No.: US 2008/0056808 A1
(43) Pub. Date: Mar. 6, 2008

(54) Monopod mounting apparatus

(76) Inventor: JoeBen Bevirt, Santa Cruz, CA (US)

Correspondence Address: MICHAEL A. GUTH, 2-2905 EAST CLIFF DRIVE, SANTA CRUZ, CA, 95062, US

(21) Appl. No.: 11/715,817

(22) Filed: Mar. 7, 2007

Related U.S. Application Data
(63) Continuation-in-part of application No. 11/637,611, filed on Dec. 12, 2006.
Application No. 11/637,611 is a continuation-in-part of application No. 11/324,994, filed on Jan. 3, 2006.

(51) Int. Cl. F16C 11/06

(52) U.S. Cl. 403/56

(57) ABSTRACT

A flexible support apparatus adapted to wrap around and grip an element, such as a pole, while, in some embodiments, supporting a device such as a camera, flash unit, cell phone, or other item. The flexible support unit may consist of a series of ball and socket connectors interconnected into a flexible chain. The flexible support unit may have removable clips at one or both ends. The clips may be adapted to support different objects in different ways.

### CROSS-REFERENCE TO RELATED APPLICATIONS

This application is a continuation in part of U.S. patent application Ser. No. 11/637,611 to Bevirt et al., with a filing date of Dec. 12, 2006, which is a continuation in part of U.S. patent application Ser. No. 11/324,994 to Bevirt, with a filing date of Jan. 3, 2006, both of which are hereby incorporated by reference in their entirety.

### BACKGROUND

1. Field of the Invention

The present invention relates to support apparatus, and more particularly to a flexible support arm with gripping features and removable mounting clips.

2. Description of Related Art

Typical support assemblies need to be hard mounted on one end in order to support an item, or have a base of some sort. What is called for is a support apparatus able to be mounted to a variety of features, such as poles, and vertical elements, with ease both of mounting and removal.

### SUMMARY

A flexible support apparatus adapted to wrap around and grip an element, such as a pole, while, in some embodiments, supporting a device such as a camera, flash unit, cell phone, or other item. The flexible support unit may consist of a series of ball and socket connectors interconnected into a flexible chain. The flexible support unit may have removable clips at one or both ends. The clips may be adapted to support different objects in different ways.

### BRIEF DESCRIPTION OF THE DRAWINGS

FIG. 1 is a view of a flexible arm assembly according to some embodiments of the present invention.

FIG. 2 is a view of a flexible arm assembly with a flash clip according to some embodiments of the present invention.

FIG. 3 is a view of a flexible arm assembly with a suction clip according to some embodiments of the present invention.

FIG. 4 is a view of a flexible arm assembly holding an electronic device according to some embodiments of the present invention.

FIG. 5 is a view of a flexible arm assembly with a clamp clip according to some embodiments of the present invention.

FIG. 6 is a view of a flexible arm assembly with a microphone clip according to some embodiments of the present invention.

FIG. 7 is a view of a flexible arm assembly according to some embodiments of the present invention.

FIG. 8 is a view of a flexible arm assembly with two interconnect portions according to some embodiments of the present invention.

FIG. 9 illustrates a side view of a plurality of connected connectors according to some embodiments of the present invention.

FIG. 10 illustrates an end view of a plurality of connected connectors according to some embodiments of the present invention.

FIG. 11 is a cross-sectional view of a plurality of connected connectors according to some embodiments of the present invention.

FIG. 12 is a side view of a connector according to some embodiments of the present invention.

FIG. 13 is a cross-sectional view of a connector according to some embodiments of the present invention.

FIG. 14 is a view of a connector according to some embodiments of the present invention.

FIG. 15 is a view of a connector with a gripping portion according to some embodiments of the present invention.

FIG. 16 is a cross sectional view of a connector with a gripping portion according to some embodiments of the present invention.

FIGS. 17 is a view of an interconnect portion according to some embodiments of the present invention.

FIG. 18 is a cross-sectional view of an interconnect portion according to some embodiments of the present invention.

FIG. 19 are a side view and a cross-section of a composite connector according to some embodiments of the present invention.

### DETAILED DESCRIPTION

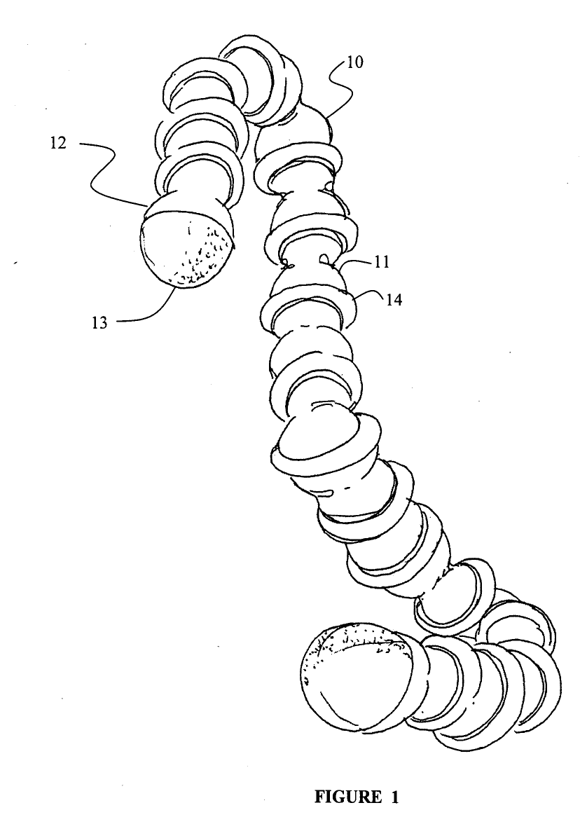

In some embodiments of the present invention, as seen in FIG. 1, a flexible arm 10 is adapted for twisting and flexing. In some embodiments, the flexible arm 11 consists of a plurality of interconnected connectors 11. The connectors 11 may be ball and socket connectors. The connectors 11 may have a gripping portion 14. The gripping portion 14 may be of a rubberized compound. The gripping portion 14 allows for better friction when the flexible arm 10 is wrapped around a feature such as a pole, for example. In some embodiments, the gripping portion is co-molded into the connector body. The co-molding process may also be referred to as overmolding or double injection molding. An end connector 12 may have a gripping pod 13. The gripping pod 13 may be of rubberized compound. In some embodiments, the flexible arm 10 may have an end connector on both ends of the flexible arm. The gripping pod may also be co-molded onto the connector. In some embodiments, the connector onto which the gripping pod is overmolded may vary from the other connectors in order to be better adapted to receiving the gripping pod. Connectors that support a gripping pod may be termed a gripping pod connector.

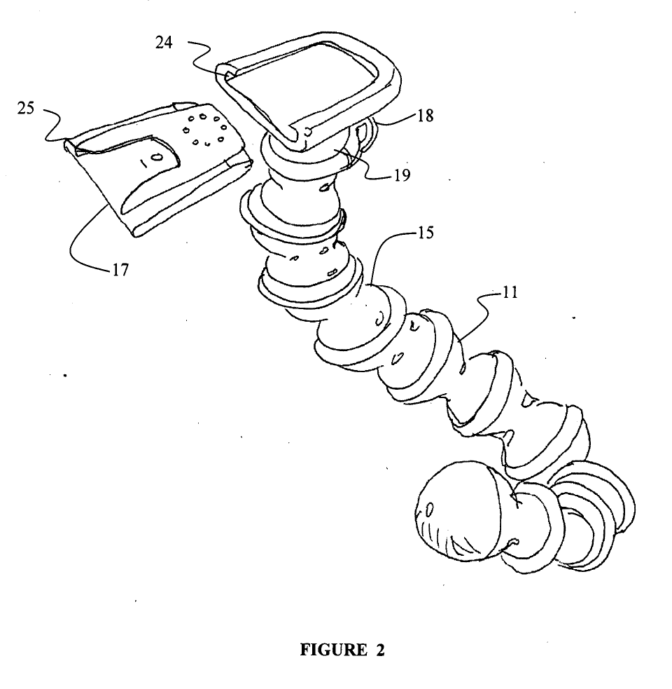

In some embodiments of the present invention, as seen in FIG. 2, a flexible arm, or monopod, 15 consists of a plurality of interconnected connectors 11 with an interconnect portion 16 on one end. The interconnect portion 16 is adapted to receive a clip 17 into its opening 24. The clip 17 may be inserted into the opening 24, which will capture the rails 25 of the clip 17, which will be captured by the interconnect portion 16. In some embodiments, the clip will have a recess in its bottom surface in the shape of a slot. A spring loaded tab 27 connected to a release lever with a button resides in the interconnect portion, allowing the clip to be pushed in and then retained as the tab first is pushed down by the insertion of the clip and then springs back up into the slot in the underside of the clamp. A spring loaded release button 18 may be pushed to release the clip 17. A rotating locking ring 34 may lock the spring loaded release button from being able to release. While a variety of different types of clips may be used with the monopod 15, the clip 17 shown in FIG. 2 is adapted to receive a camera flash unit.

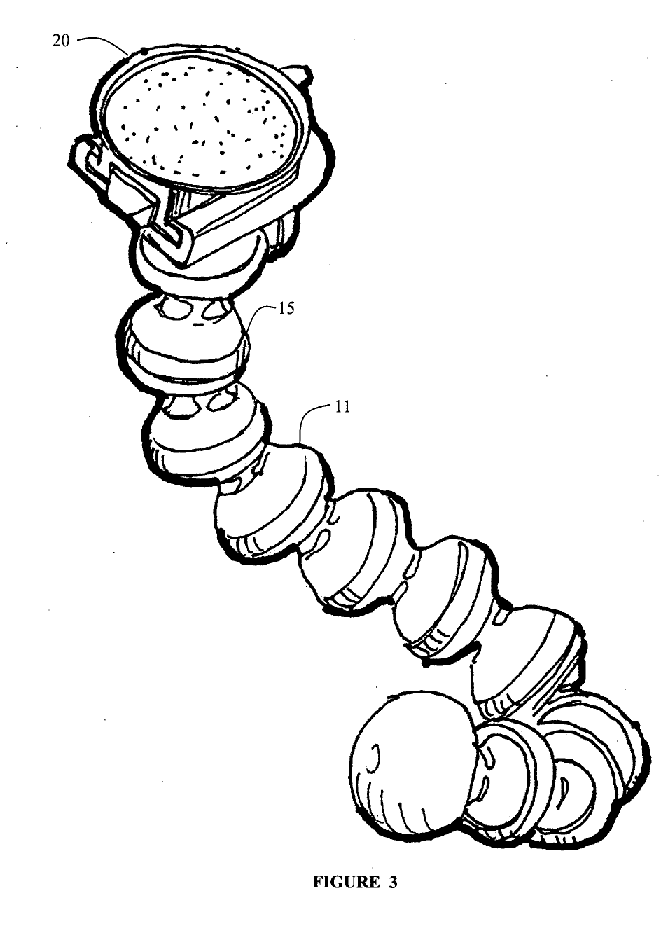

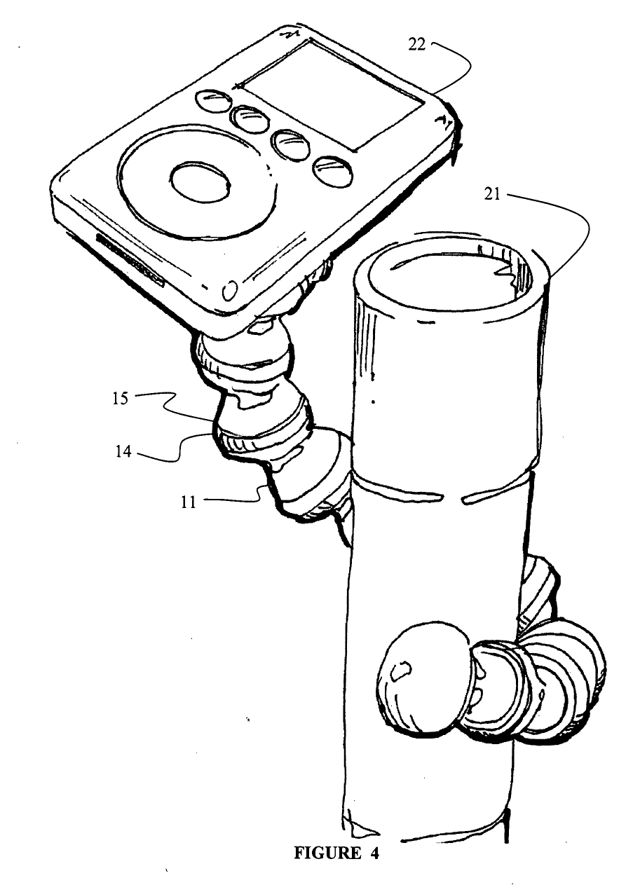

In some embodiments of the invention, as seen in FIG. 3, a monopod 15 is seen with another type of clip, a suction clip 20. The suction clip allows for the mounting of a variety of types of objects. As seen in FIG. 4, the monopod 15 has been wrapped around a vertical element 21. The gripping portions 14 greatly enhance the ability of the monopod stay in the position intended by the user, and greatly reduces the likelihood of the monopod slipping down. An electronic device 22 is seen mounted on the monopod 15.

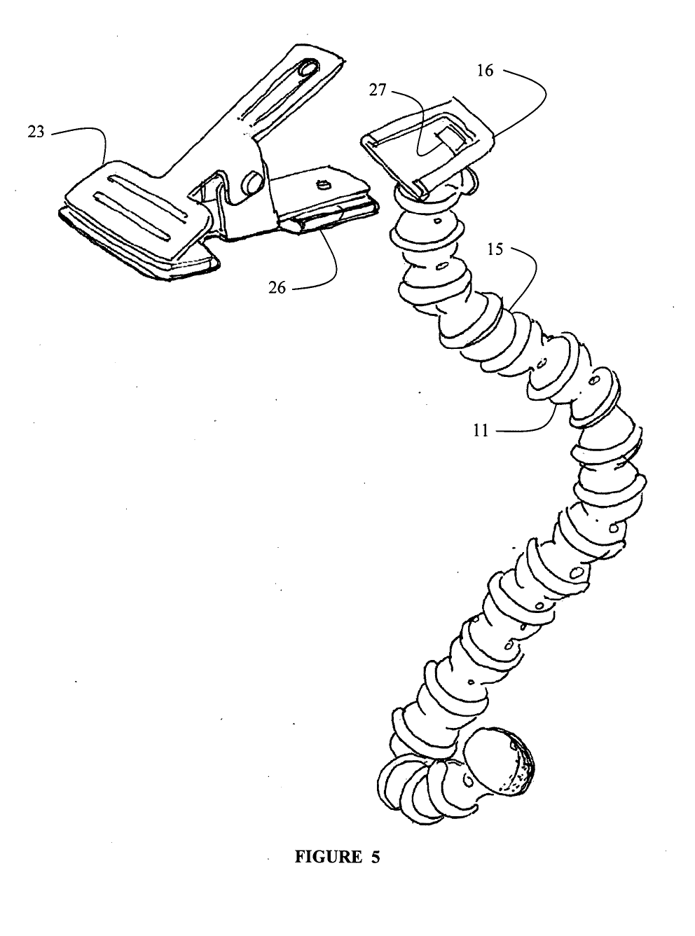

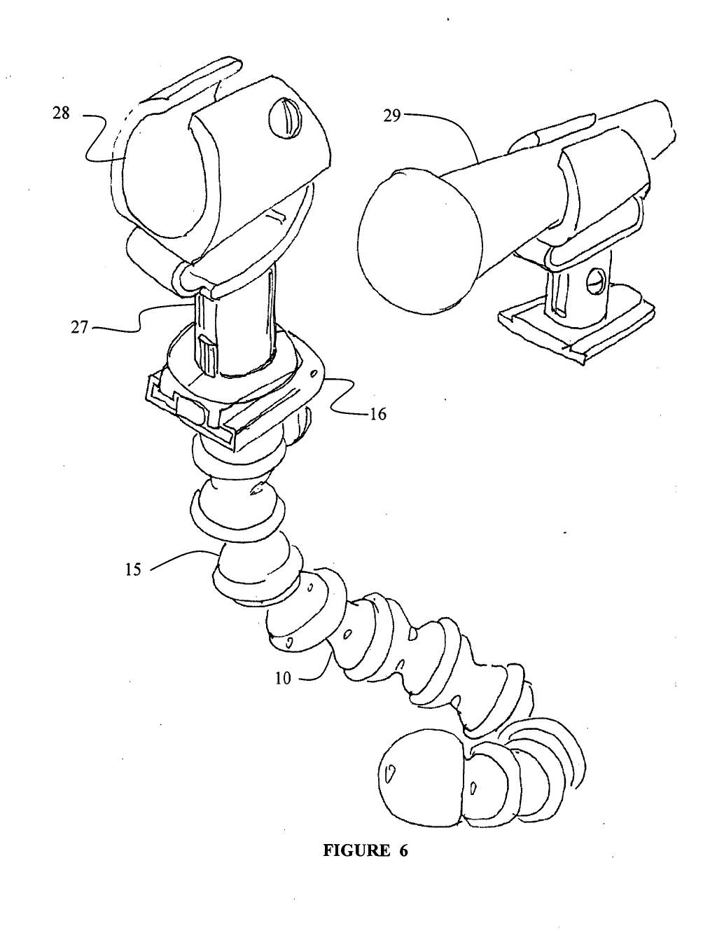

FIGS. 5 and 6 illustrate further embodiments of the present invention. A clamp clip 23 is seen with a clip 26 adapted to be received by the interconnect portion 16. A spring loaded tab 27 connected to a release lever with a button resides in the interconnect portion, allowing the clip to be pushed in and then retained as the tab first is pushed down and then springs back up into the slot in the underside of the clamp. A spring loaded release button 18 may be pushed to release the clip 17. A rotating locking ring 34 may lock the spring loaded release button from being able to release. A microphone clamp 27 adapted to be received by the interconnect portion is seen with a holder 28 for a microphone 29.

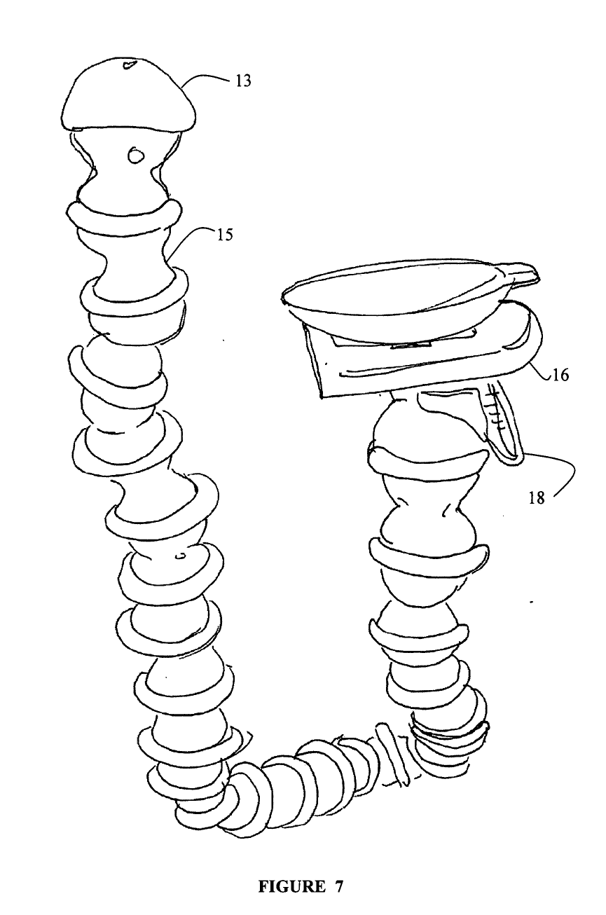

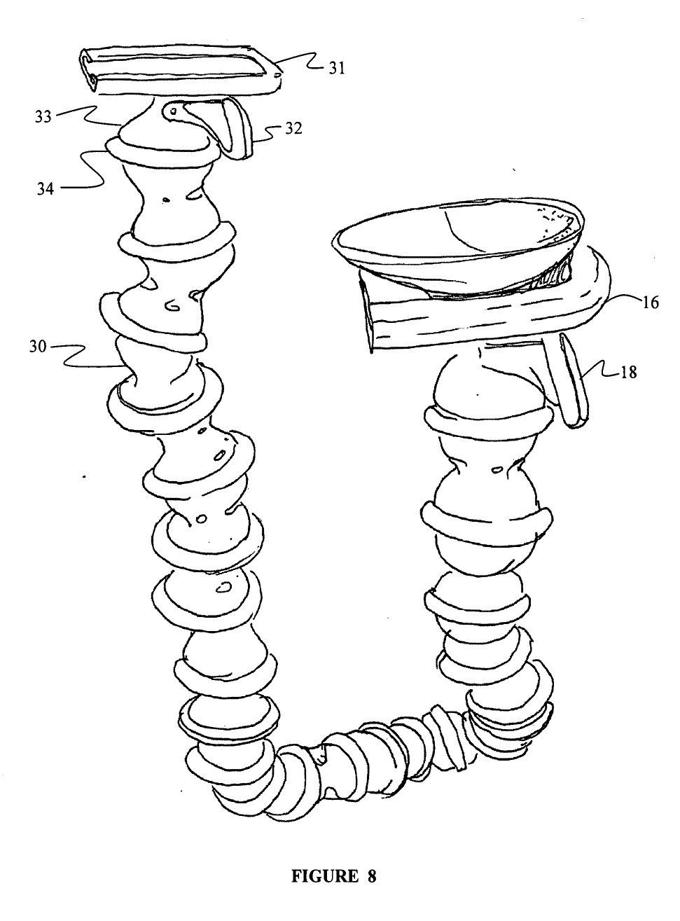

FIGS. 7 and 8 contrast differing embodiments according to some embodiments of the present invention. FIG. 7 illustrates a monopod 15 with suction cup mounted into the interconnect portion on a first end, and a gripping pod at a second end. FIG. 8 illustrates a monopod 30 with suction cup clip mounted onto an interconnect portion 16 on a first end. The clip may be released from the interconnect portion 16 by pressing a release button 18. At the second end, a second interconnect portion 33 is seen. The second interconnect portion 33 is adapted to receive a clip in its receiver 31. A release button 32 releases the captured clip. The interconnect portion may also have a grip ring 34. The first interconnect portion and the second interconnect portion may differ somewhat from each other as one is opposite that male end of the connector and one is opposite the female end of a connector.

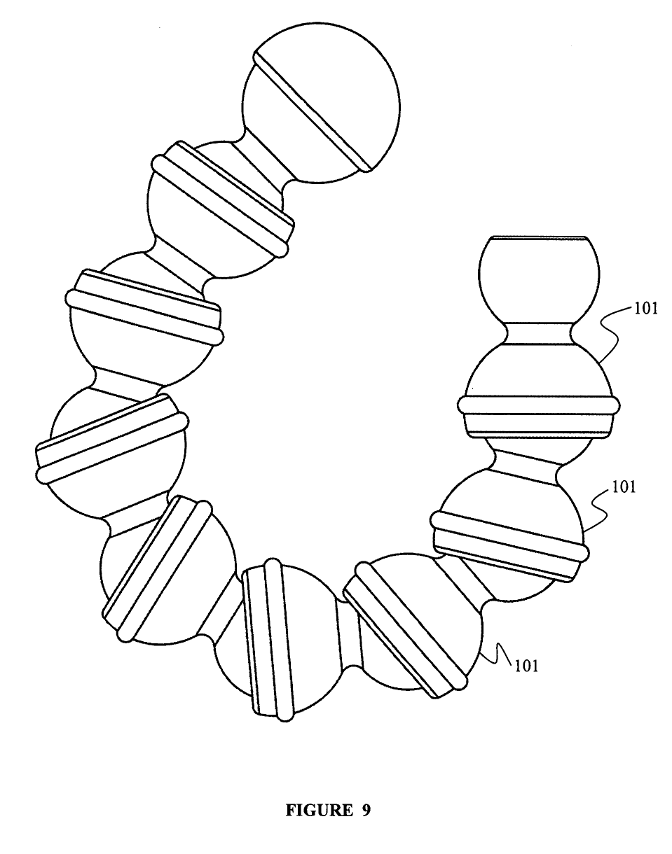

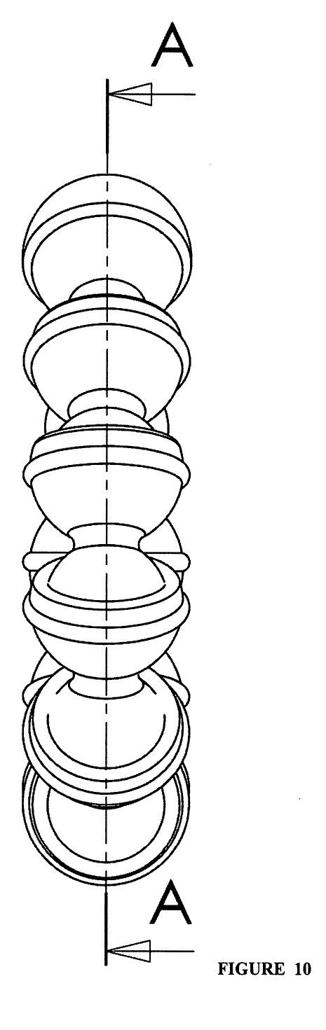

FIGS. 9, 10, and 11 illustrate a flexible arm with a plurality of ball and socket joint connectors 101 according to some embodiments of the present invention. A connector 101 has a first end portion 102 and a second end portion 103. A socket engaging end surface 104 is present at the first end 102. The first end portion 102 is substantially hollowed out in some embodiments.

The second end portion 103 has a body 106 with an internal socket receiving cavity 107. The inner surface 110 of the an internal socket receiving cavity 107 is adapted to fit over the socket engaging end surface 104 of another connector 101, or of another piece with a similar socket engaging end surface. A neckdown 105 separates the first end portion 102 from the second end portion 103. A stop nub 108 acts as a mechanical stop to prevent over angulation and possible unintentional separation of a ball and socket joint connector pair.

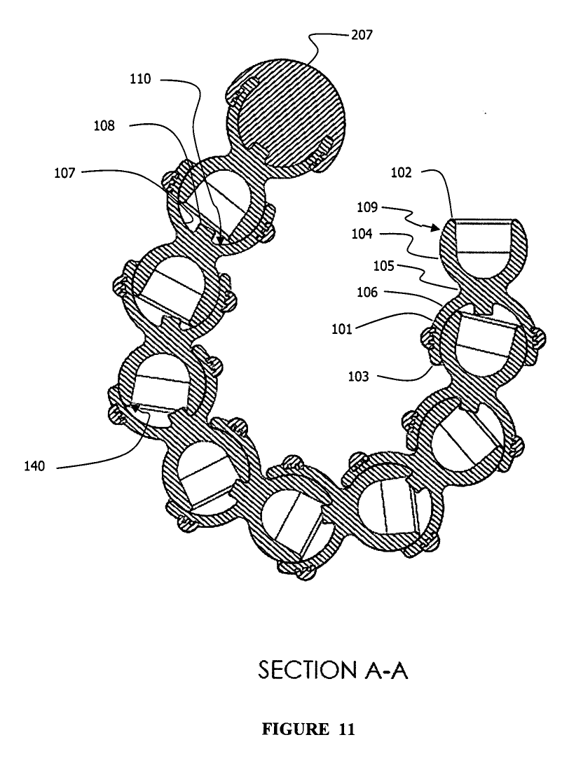

FIG. 11 illustrates a cross-sectional view of a plurality of ball and socket joint connectors. In some embodiments of the present invention, a stop nub 108 resides within the internal socket receiving cavity. The inner rim 140 of the socket engaging end surface 104 is adapted to contact the stop nub 108 as the two connectors reach a certain angle relative to each other. The contact of the stop nub 108 and the inner rim 140 of the socket engaging end surface 104 acts as a mechanical stop with regard to further angulation of the two pieces relative to each other. The mechanical stop function works to prevent over-rotation and possible disconnection of the two connectors. As seen in cross-section in FIG. 11, the gripping pod 207 may be fully molded into the cavity of the connector.

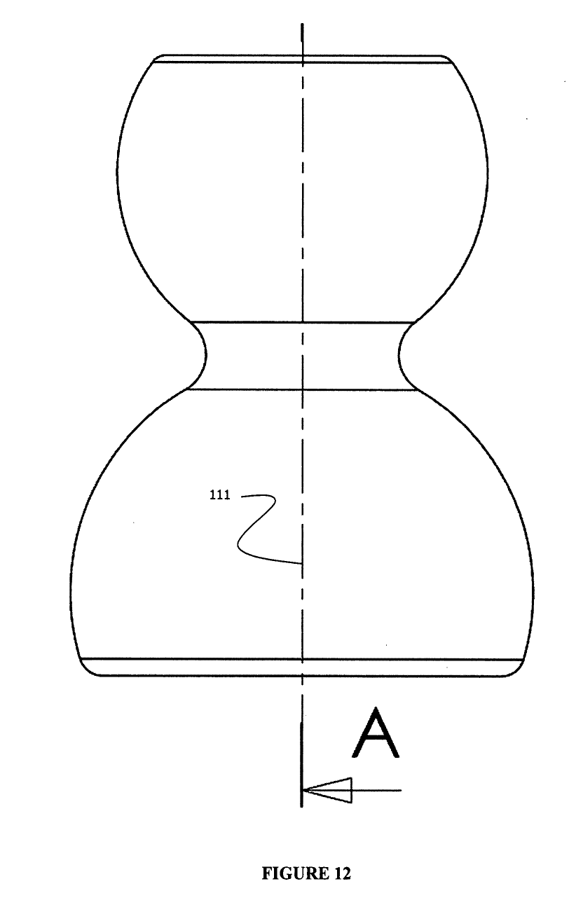

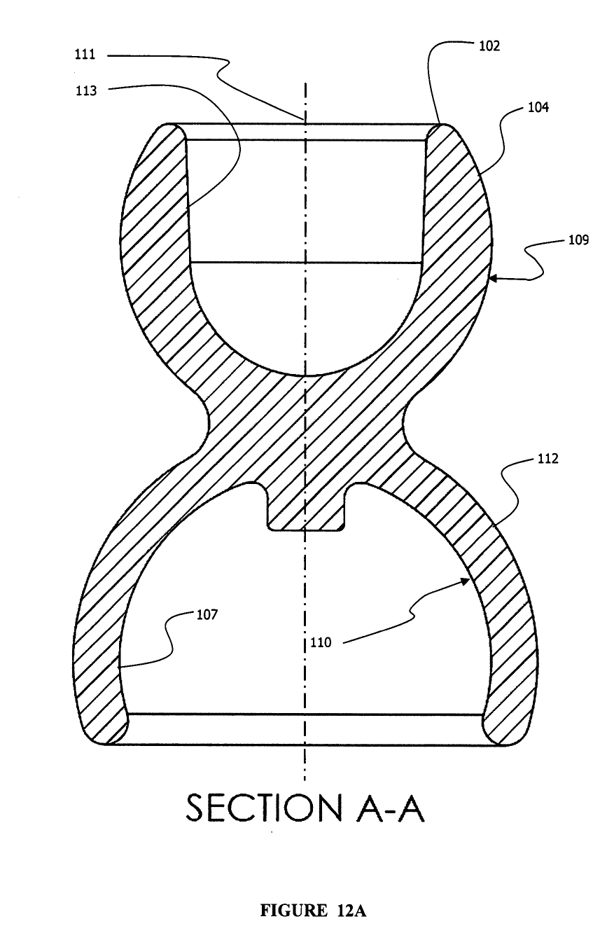

As seen in FIGS. 12 and 13, the connector 101 has a primary axis 111 in some embodiments. The connector 101 may be symmetric around the primary axis 111 in some embodiments. The end surface planes of the first and second end portions of the connector may be perpendicular to the primary axis 111 in some embodiments.

In some embodiments of the present invention, the wall thicknesses of the internal socket receiving cavity or the socket engaging end surface, or both, are constructed so that an interference fit remains after the ball and socket joint connectors are connected. In some embodiments, the interference fit is designed such that the material is stressed to a stress level below that of the plastic limit but above the creep limit. The material may then creep until the interference is at or below the creep limit, typically down to the upper end of the elastic deformation stress range of the material. In such an embodiment using a plurality of connectors connected together to form a longer chain, the stresses will tend to equalize in the different connector pairs. This equalization of stresses will tend to equalize the frictions of the various connector pairs. An equalization of the frictions in the connector pairs in a long chain of connected connectors will tend to allow the chain of connectors to bend in a smooth fashion when the chain is subjected to bending forces. For example, in a 10 unit chain bent to a 45 degree angle, the bending may be well spread among the connector pairs.

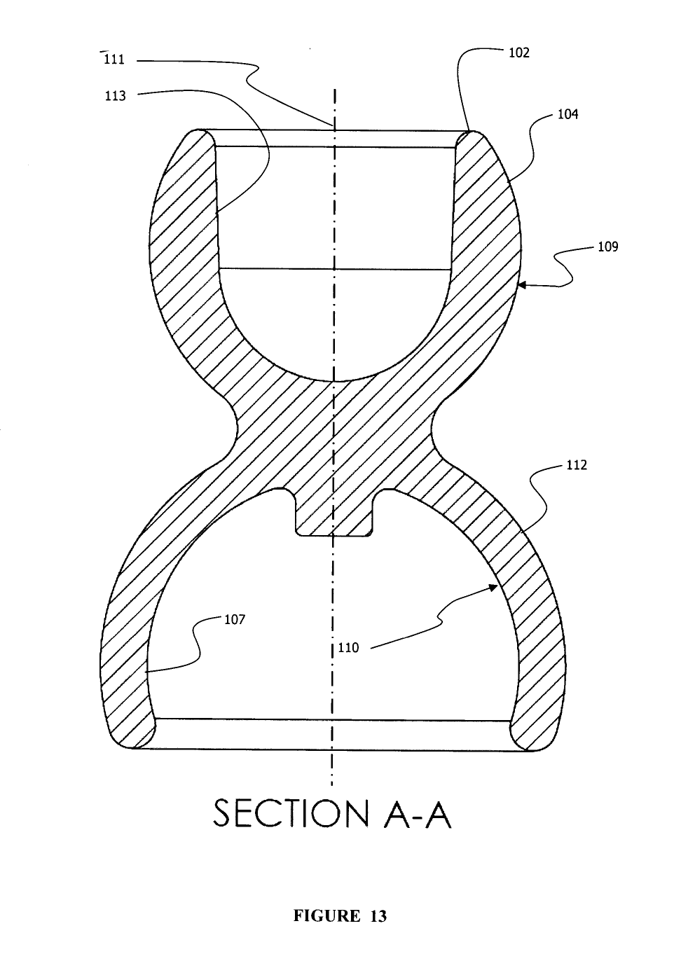

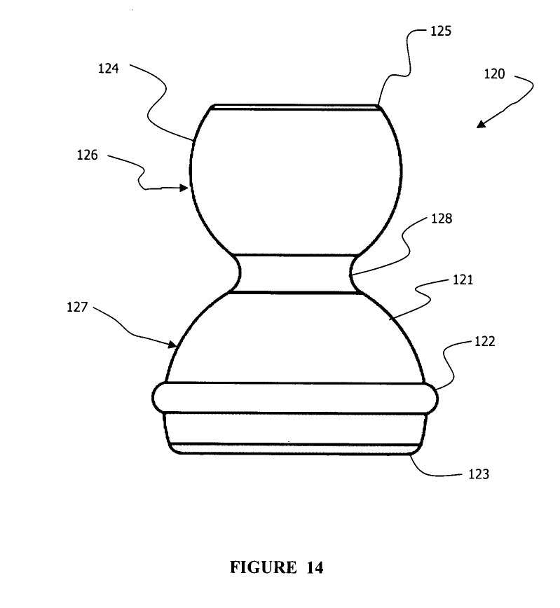

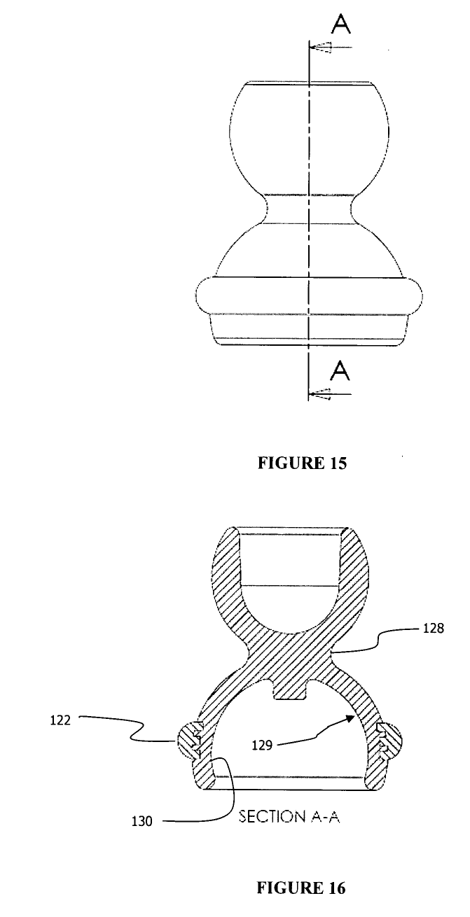

In some embodiments, as seen in FIGS. 14, 15 and 16, a connector 120 includes a gripping portion 122. The connector 120 has a first end portion 125 and a second end portion 123. A socket engaging end surface 124 is present at the first end 125. The first end portion 125 is substantially hollowed out. The connector may be made of thermo-plastic elastomer, or of other materials.

The second end 123 has a body 121 with an internal socket receiving cavity 130. The inner surface 129 of the an internal socket receiving cavity 130 is adapted to fit over the socket engaging end surface 124 of another connector, or of another piece with a similar socket engaging end surface. A neckdown 128 separates the first end portion 125 from the second end portion 123. A gripping portion 122 allows the connector to grip surfaces more readily. In some embodiments, the gripping portion is co-molded into the connector body. The co-molding process may also be referred to as overmolding. In some embodiments, the gripping portion is a rubberized compound. In some embodiments, the gripping portion is a circumferential ring molded into the outer surface of the connector. The gripping portion may provide a higher friction interface when the connector is set upon or wrapped around an object.

In some embodiments of the present invention, the outer surface 109 of the socket engaging end surface 104 may be lubricated. Lubrication of the outer surface 109 of the socket engaging end surface 104 may allow for more even frictions between various connections in a chain of connectors. In some embodiments, the inner surface 110 of the internal socket receiving cavity 107 may be lubricated. Lubrication of the inner surface 110 of the internal socket receiving cavity 107 may allow for more even frictions. In some embodiments, both the outer surface 109 of the socket engaging end surface 104 and the inner surface 110 of the an internal socket receiving cavity 107 may be lubricated. In some embodiments, the surfaces may be coated with an adhesive. With some connector materials, such as acetyl materials, Delrin, and Nylon, compounds normally used as adhesive may function as a lubricant when used in an interference fit ball and socket joint connector.

In some embodiments of the present invention, the outer surface 109 of the socket engaging end surface 104 may be textured. The texture may take the form of a surface roughness. Texturing of the outer surface 109 of the socket engaging end surface 104 may allow for more even frictions between various connections in a chain of connectors. In some embodiments, the inner surface 110 of the internal socket receiving cavity 107 may be textured. The texture may take the form of a surface roughness. Texturing of the inner surface 110 of the internal socket receiving cavity 107 may allow for more even frictions. In some embodiments, both the outer surface 109 of the socket engaging end surface 104 and the inner surface 110 of the an internal socket receiving cavity 107 may be lubricated.

In some embodiments, the flexible arm is connected to an interconnect portion 205. A clip 220 is removably fastened to the interconnect portion 205. The clip 220 may have a threaded post adapted to fit into a camera or other device in some embodiments. As described above and as seen in the other patent applications incorporated by reference, other clips may be used.

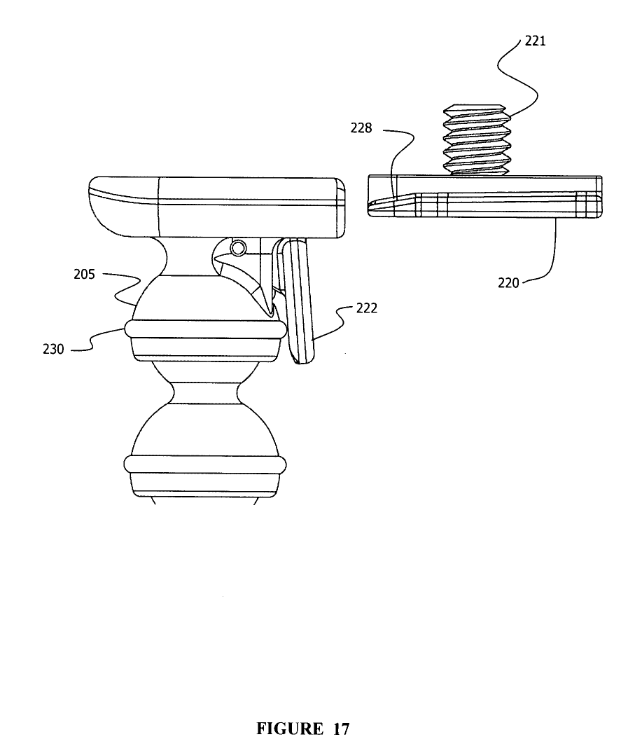

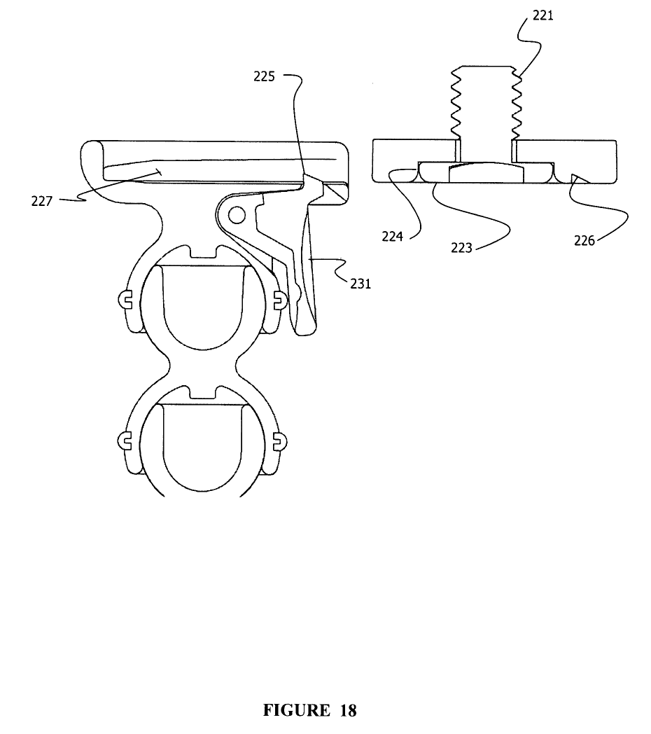

In some embodiments of the present invention, as further illustrated in FIGS. 17 and 18, the interconnect portion 205 is adapted to receive a clip 220. The clip 220 may have rails 228 adapted to slide into slots 227 within the interconnect portion 205. The clip 220 may have recess 226 adapted to be filled by a tab 225 on a spring loaded lever 222. The clip is removably attached to the interconnect portion 205 and may be released by pressing on the lever 222. In some embodiments, the lever 222 is on the same side of the interconnect portion 205 as which the clip 220 slides in on. In other embodiments, the lever 222 is on the side opposite that which the clip 220 slides in on.

The interconnect portion may have a rotatable locking ring 230 with a cam that allows the release button 231 of the spring loaded lever 222 to be pushed, thereby allowing the clip to be removed, in a first position, and when rotated to a second position fills the space behind the release button 231, preventing the spring loaded lever 222 from disengaging the clip.

A mounting screw 221 may be recess mounted into the clip 220 in some embodiments. The screw 223 may be of the standard size and thread to attach to a camera in some embodiments. The head 223 of the screw 221 may be held into the recess 224 by a slight ridge in the molding of the recess in some embodiments.

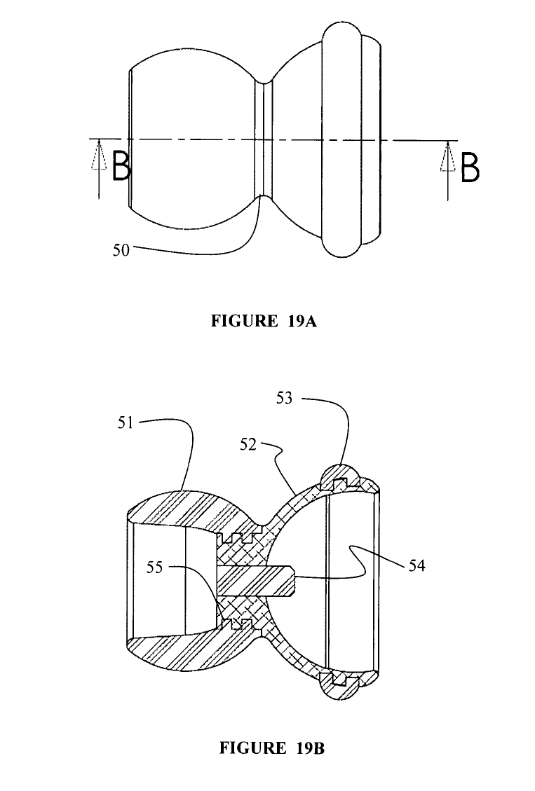

In some embodiments of the present invention, as seen in FIG. 19, a connector 50 may be made from more than one material. The first end portion and the second end portion may be of different materials. For example, the socket engaging end surface 51, along with the rest of the first end portion, may be of an ABS plastic. The internal socket receiving cavity 52, as well as the second end portion, may be of another material, such as aluminum. In some embodiments, the bulk of the second end portion may machined from metal, such as aluminum. The internal mating surface of the socket receiving cavity may be machined to a desired roughness. A series of grooves 55 may be left on the external surface of the second end portion to facilitate the molding of the first end portion over the second end portion. A stop pin 54 may also be molded at the same time and of the same material. A grip strip 53 may be molded of the same material, or of a softer material, as desired. The grip strip 53 may be added in second overmolding, or double injection, process.

The selection of differing materials may offer a variety of advantages. For example, the frictions between the two materials may be ideal for a particular use. Also, as in the case of using a metal such as aluminum, the connector may be much stiffer than a connector made solely of plastic. In the case of a support structure made of a length of connectors, the stiffness added to each connector may greatly affect the stiffness of the overall structure.

Another distinct advantage of a composite connector may be that using a metal for the socket, which is primarily under tensile stress, as opposed to a plastic, reduces the likelihood over time of creep induced relaxation of the fit of the ball and socket. Also, if the ball and socket are ever disengaged, it may be that the plastic socket is more susceptible to permanent deformation, and the use of a metal socket may allow the connectors to be connected and disconnected in a manner that may not be suitable with all plastic connectors.

Although the foregoing discussion has involved plastic and metal, other combinations of materials may be used. For example, nylon may be used with plastic. Other suitable combinations may also be used.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A flexible arm comprising:
a plurality of interconnected connectors, said plurality of interconnected connectors having a first end and a second end, said connectors comprising:
a connector main body, said main body comprising:
a socket engaging end surface at a first end, said socket engaging end surface being an external surface at said first end; and
an internal socket receiving cavity at a second end; and
a gripping portion, said gripping portion overmolded onto said connector main body.

2. The apparatus of claim 1 wherein said gripping portion comprises a rubberized compound.

3. The apparatus of claim 2 wherein said gripping portion comprises a circumferential ring co-molded onto the outer surface of said second end portion of said connector body.

4. The apparatus of claim 1 wherein said flexible arm further comprises a gripping pod at a first end of said flexible arm.

5. The apparatus of claim 4 wherein said flexible arm further comprises a gripping pod at its second end.

6. The apparatus of claim 4 wherein said gripping pod comprises a rubberized compound.

7. The apparatus of claim 1 wherein said flexible arm further comprises a gripping pod connector at the first end of said flexible arm, said gripping pod connector comprising a gripping pod.

8. The apparatus of claim 7 wherein said flexible arm further comprises a gripping pod connector at the second end of said flexible arm, said gripping pod connector comprising a gripping pod.

9. The apparatus of claim 1 wherein the first end of the connector main body comprised a first material, and wherein the second end of the connector main body comprises a second material.

10. A flexible arm comprising:
a plurality of interconnected connectors, said plurality of interconnected connectors having a first end and a second end, said connectors comprising a connector main body, said main body comprising a first end and a second end; and
a first interconnect portion connected to said first end of said plurality of interconnected connectors, said first interconnect portion adapted to receive a first clip.

11. The flexible arm of claim 10 further comprising a first clip removably attached to said first interconnect portion.

12. The flexible arm of claim 10 wherein said connectors further comprise a gripping portion.

13. The flexible arm of claim 12 wherein said gripping portion is overmolded onto said connector main body.

14. The apparatus of claim 12 wherein said gripping portion comprises a circumferential ring overmolded onto the outer surface of said second end portion of said connector body.

15. The apparatus of claim 10 further comprising a gripping connector connected to said second end of said plurality of interconnected connectors.

16. The apparatus of claim 15 wherein said gripping connector comprises a gripping pod.

17. The apparatus of claim 10 further comprising a suction cup clip, said suction cup clip removably attached to said interconnect portion.

18. The apparatus of claim 10 further comprising a clamp clip, said clamp clip removably attached to said interconnect portion.

19. The flexible arm of claim 10 further comprising a second interconnect portion connected to said second end of said plurality of interconnected connectors, said second interconnect portion adapted to receive a second clip, said second interconnect portion connected to said second end of said plurality of flexible connectors.

20. The flexible arm of claim 11 further comprising a second interconnect portion connected to said second end of said plurality of interconnected connectors, said second interconnect portion adapted to receive a second clip, said second interconnect portion connected to said second end of said plurality of flexible connectors.

21. The flexible arm of claim 20 further comprising a second clip, said second clip removably attached to said second interface portion.
